(19) United States
(12) Patent Application Publication
(10) Pub. No.: US 2015/0106764 A1
(43) Pub. Date: Apr. 16, 2015

(54) Enhanced Input Selection

(71) Applicant: Apple Inc., Cupertino, CA (US)

(72) Inventor: Ray L. Chang, Sunnyvale, CA (US)

(73) Assignee: Apple Inc., Cupertino, CA (US)

(21) Appl. No.: 14/054,018

(22) Filed: Oct. 15, 2013

(51) Int. Cl. G06F 3/0482; G06F 3/0488; G06F 3/01

(52) U.S. Cl. CPC G06F 3/0482; G06F 3/017; G06F 3/0488
USPC 715/810

(57) ABSTRACT

A touch sensor of an electronic device that is used to navigate one or more presented lists is operable in at least a gesture mode and a character mode. In the gesture mode, one or more touches detected by the touch sensor are interpreted as gesture input for navigating the list. In the character mode, the touches are interpreted as character input for navigating the list. The touch sensor switches between the gesture mode and the character mode and may also switch between these modes and one or more other modes. The electronic device may be a remote control that controls another electronic device.

### TECHNICAL FIELD

This disclosure relates generally to input selection, and more specifically to input selection that switches between a gesture mode and a character mode.

### BACKGROUND

Electronic devices often receive user input via one or more input/output devices. Upon receipt of such user input, such electronic devices may perform one or more functions such as updating a displayed user interface. Such input/output devices may include one or more keyboards, mice, buttons, touch screens, track pads, touch pads, microphones, virtual keyboards, and so on.

In some cases, the user input may be received by a remote control device that may relay the user input to the electronic device. Some remote control devices may receive user input via one or more touch sensors and/or similar input/output devices. In such a case, one or more user touches may be interpreted as one or more gesture inputs by the remote control device and/or the electronic device.

For example, the electronic device may present a list. The user may move his finger upward or downward on a touch sensor and this touch may be interpreted as an up swipe or a down swipe. In response, the display of the list may be scrolled in accordance with the direction of the swipe.

### SUMMARY

The present disclosure discloses systems and methods for input entry. A touch sensor of an electronic device that may be used to navigate one or more presented lists may be operable in at least a gesture mode and a character mode. In the gesture mode, one or more touches detected by the touch sensor may be interpreted as gesture input for navigating the list. In the character mode, the touches may be interpreted as character input for navigating the list. The touch sensor may switch between the gesture mode, the character mode, and/or one or more other modes.

In some implementations, the list may be presented by the electronic device. However, in other implementations, the list may be presented by a second electronic device that is controllable by the electronic device. In such implementations, the electronic device may be a remote control capable of transmitting commands and/or other instructions to the second electronic device. Further, in such cases the remote control may lack components for presenting the list.

In various implementations, the touch sensor may switch between the gesture mode and the character mode based on input from the user. For example, the touch sensor may switch from the gesture mode to the character mode in response to detecting a particular gesture associated with switching modes. Such a gesture may be defined by the user. In other implementations, the mode of the touch sensor may switch based on a context associated with the touch sensor. For example, when the touch sensor is incorporated into a remote utilized to control an electronic device that presents a user interface, the touch sensor may switch from the gesture mode to the character mode when the focus of the user interface enters a portion of the user interface configured for character input such as a text entry box.

In one or more embodiments, a system for input entry may include at least one processing unit and at least one touch sensor. The touch sensor may be operable in at least a gesture mode where at least one touch detected by the touch sensor is interpreted as at least one gesture input for navigating at least one list and a character mode where the touch detected by the touch sensor is interpreted as at least one character input for navigating the list.

In some embodiments, a method for input entry may include interpreting a first touch input detected by a touch sensor as a gesture for navigating a list when operating the touch sensor in a gesture mode; determining to switch the touch sensor to a character mode; and interpreting a second touch input detected by the touch sensor as a character for navigating the list when operating the touch sensor in a character mode.

In various embodiments, an electronic device may include a processing unit and a touch sensor coupled to the processing unit. The touch sensor may be operable in at least a gesture mode where at least one touch detected by the touch sensor is interpreted as a gesture input for navigating at least one list and a character mode where the touch detected by the touch sensor is interpreted as a character for navigating the list.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is a isometric view of a system for input entry.

FIG. 1B is a block diagram illustrating example components and functional relationships of the system of FIG. 1A.

FIG. 1C is a close-up view of a first touch on the touch sensor of the system of FIG. 1A.

FIG. 1D is a close-up view of a second touch on the touch sensor of the system of FIG. 1A.

FIG. 1E is a close-up view of a third touch on the touch sensor of the system of FIG. 1A.

FIG. 2 is a flow chart illustrating a method for input entry. This method may be performed by the system of FIG. 1A.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for input entry. A touch sensor of an electronic device that may be used to navigate one or more presented lists may be operable in at least a gesture mode and a character mode. In the gesture mode, one or more touches detected by the touch sensor may be interpreted as gesture input (such as one or more taps, swipes, slides, touches, pinches, and/or any other combination of one or more touches interpretable as a gesture) for navigating the list. In the character mode, the touches may be interpreted as character input (such as one or more letters of the English or other alphabet, one or more numbers, one or more Chinese characters and/or other logograms or ideograms, one or more symbols, one or more user defined characters, and/or any other character) for navigating the list. The touch sensor may switch between the gesture mode, the character mode, and/or one or more other modes.

In some implementations, the list may be presented by the electronic device. However, in other implementations, the list may be presented by a second electronic device (such as a television or other device) that is controllable by the electronic device. In such implementations, the electronic device may be a remote control capable of transmitting commands and/or other instructions to the second electronic device (and/or receiving communications from the second electronic device). Further, in such cases the remote control may lack components (such as a display or speaker) for presenting the list.

In various implementations, the touch sensor may switch between the gesture mode and the character mode based on input from the user. For example, the touch sensor may switch from the gesture mode to the character mode in response to detecting a particular gesture associated with switching modes. Such a gesture may be defined by the user.

In other implementations, the mode of the touch sensor may switch based on a context associated with the touch sensor. For example, when the touch sensor is incorporated into a remote utilized to control an electronic device that presents a user interface, the touch sensor may switch from the gesture mode to the character mode when the focus of the user interface enters a portion of the user interface configured for character input such as a text entry box.

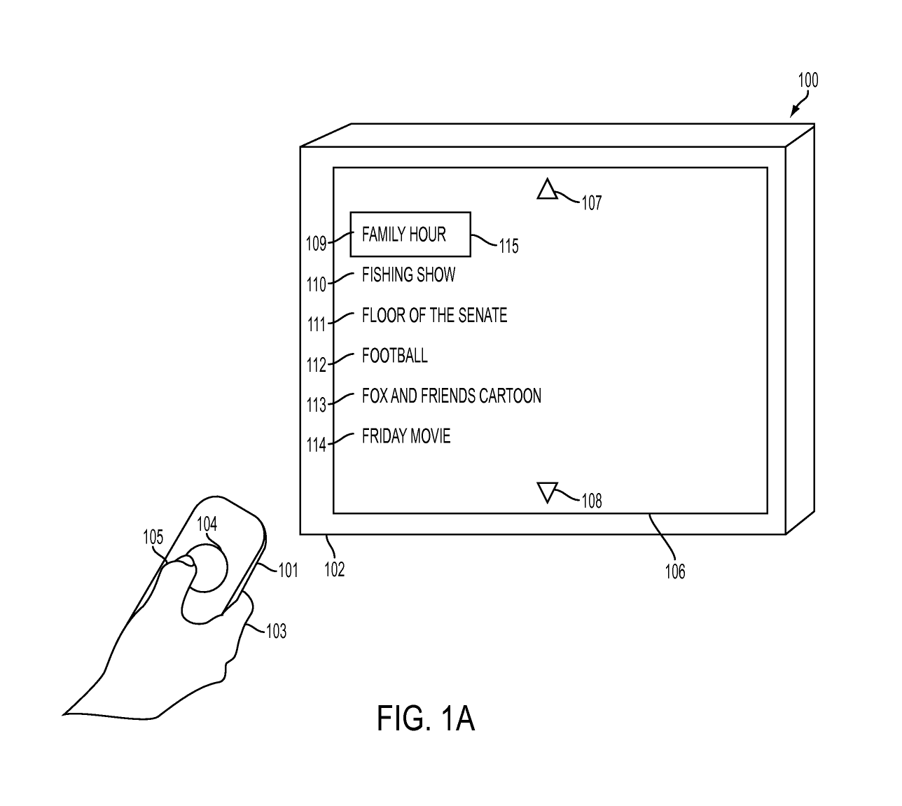

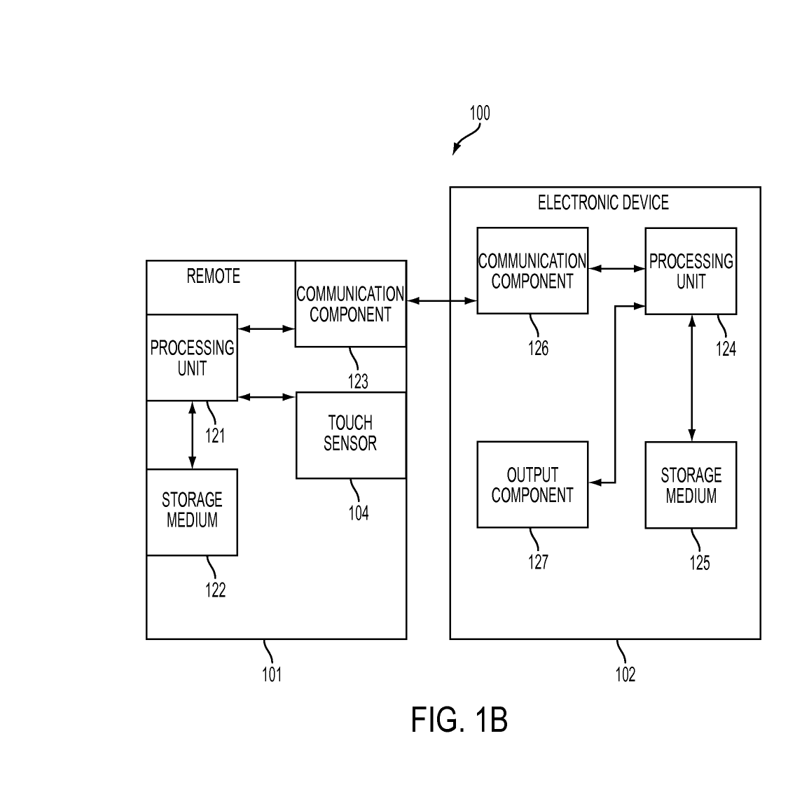

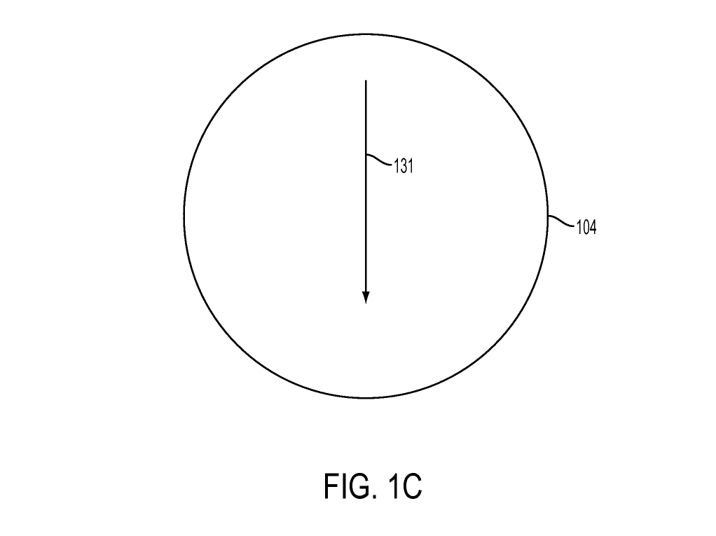

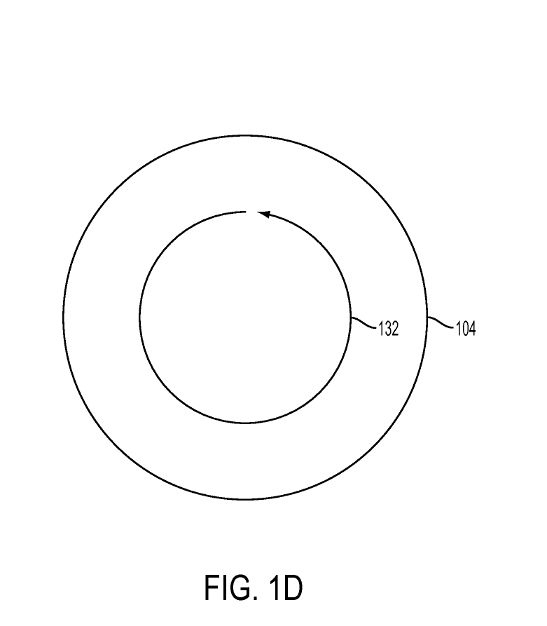

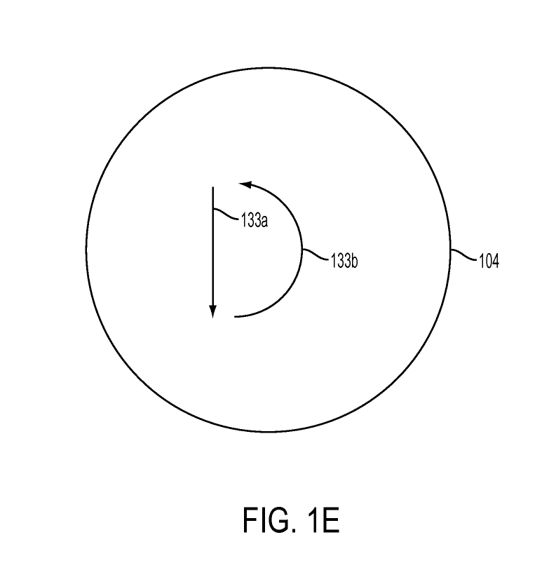

FIG. 1A is a isometric view of a system 100 for input entry. The system may include a first electronic device 101 and a second electronic device 102. As illustrated, the second electronic device is a television and the first electronic device is a remote control configured to transmit instructions to the television.

However, it is understood that this is an example. In various implementations, the first electronic device 101 and/or the second electronic device 102 may be any kind of electronic device and are not limited to televisions and remote controls. For example, such electronic device may be one or more laptop computing device, desktop computing devices, tablet computing devices, mobile computing devices, cellular telephones, smart phones, wearable devices, digital media players, set top boxes, kitchen appliances, automobiles, security system, and/or any other kind of electronic device.

As illustrated, the first electronic device 101 includes one or more touch sensors 104 that may detect one or more touches from a user 103. As shown, the touch sensor may detect a touch from the thumb 105 of the user, though this is not intended to be limiting and such a touch sensor may detect any kind of touches. Such a touch sensor may be any kind of touch sensor such as a touch screen, a track pad, a capacitive touch sensor, a resistance touch sensor, a piezoelectric touch sensor, a mechanical touch sensor, a pressure sensor, an ultrasonic touch sensor, a proximity sensor, and/or any other kind of sensor operable to detect one or more touches.

As also illustrated, the second electronic device 102 presents a list displayed on a display screen 106. This is an example and it is understood that lists may be presented in a variety of other ways than being displayed on a display such as presented audibly via one or more speakers and/or other such presentation mechanisms.

In this example, the list is illustrated as a portion of an alphabetized list of television content 109-114 available for selection. Selection indicator 115 may be utilized to select one of the list items in the portion currently displayed and may be moved among currently presented items in the list based on one or more touches detected by the touch sensor 104. As illustrated, the selection indicator is currently arranged to select item 109 corresponding to a television program titled “Family Hour.” Indicators 107 and 108 may respectively indicate that additional list items are not currently displayed that respectively precede and follow the currently displayed portion. The indicators may be respectively selected to present the preceding or following list items.

FIG. 1B is a block diagram illustrating example components and functional relationships of the first electronic device 101 and the second electronic device 102 of the system 100. As illustrated, the first electronic device may include the touch sensor 104, one or more processing units 121, one or more non-transitory storage media 122 (which may take the form of, but is not limited to, a magnetic storage medium; optical storage medium; magneto-optical storage medium; read only memory; random access memory; erasable programmable memory; flash memory; and so on), and/or one or more communication components 123. The processing unit 121 may execute one or more instructions stored in the storage medium 122 to perform one or more first electronic device functions. Such functions may include detecting one or more touches utilizing the touch sensor, interpreting detected touches, switching between modes (such as gesture mode, character mode, and/or other modes), transmitting instructions to the second electronic device 102 (such as detected touches, interpretation of detected touches, mode switches, instructions associated with detected touches, and so on) via the communication component 123, and so on.

As also illustrated, the second electronic device 102 may include one or more processing units 124, one or more non-transitory storage media 125, one or more communication components 126, and/or one or more output components 127 (such as one or more displays, speakers, haptic devices, printers, and/or other such output devices). The processing unit 124 may execute one or more instructions stored in the storage medium 125 to perform one or more second electronic device functions. Such functions may include receiving and/or reacting to one or more instructions received from the first electronic device 101 (such as detected touches, interpretation of detected touches, mode switches, instructions associated with detected touches, and so on) via the communication component 126, presenting one or more user interfaces and/or other content via the output component, and so on.

Although the first electronic device 101 and the second electronic device 102 are illustrated and described as including particular components, it is understood that this is an example. In other implementations, the first electronic device and/or the second electronic device may include various different components.

Returning to FIG. 1A, the touch sensor 104 may operate in a gesture mode where one or more touches detected by the touch sensor may be interpreted as one or more gestures. Such gestures may include one or more taps, swipes, slides, touches, pinches, and/or any other combination of one or more touches interpretable as a gesture.

For example, FIG. 1C is a close-up view of a first touch 131 on the touch sensor 104 that may be detected while the touch sensor is operating in the gesture mode. As illustrated, the first touch may be a downward swipe. Such a downward swipe (with reference to FIG. 1A) may be interpreted as an instruction to move the selection indicator 115 down to one of the items 110-114 that are not currently selected, to display following list items that are not currently displayed, and so on.

The touch sensor 104 may also switch between the gesture mode and a character mode (and/or one or more other modes). In the character mode, one or more touches detected by the touch sensor may be interpreted as one or more characters. Such characters may include one or more letters of the English or other alphabet, one or more numbers, one or more Chinese characters and/or other logograms or ideograms, one or more symbols, one or more user defined characters, and/or any other character.

In some cases, the touch sensor 104 may switch modes based on input from the user 103. For example, the touch sensor may switch from the gesture mode to the character mode when a specific gesture is detected (which may be a user defined gesture for switching modes). Alternatively, the touch sensor may switch from the gesture mode to the character mode (and/or from the character mode to the gesture mode based on user input received from a hardware input selection element (not shown) such as a button, a side touch slider, and/or any other input selection element.

FIG. 1D is a close-up view of a second touch 132 on the touch sensor 104 that may be detected while the touch sensor is operating in the gesture mode. As illustrated, the second touch traces a circle. Such a circular trace may be associated with switching modes from the gesture mode to the character mode. In response to detecting the second touch, the touch sensor may therefore switch from the gesture mode to the character mode.

However, in other cases, the touch sensor 104 may switch modes based on other factors. In various cases, the touch sensor may switch modes based on the mode of input currently expected by an area of a presented user interface which currently is selected. For example, when focus is transferred to a text box, the mode may be switched from gesture mode to character mode (or may remain in character mode if operating previously in character mode). By way of another example, when focus is transferred from a text box to a user interface portion navigable by gestures, the mode may be switched from character mode to gesture mode (or may remain in gesture mode if operating previously in gesture mode).

FIG. 1E is a close-up view of a third touch 133a and 133b on the touch sensor 104 that may be detected while the touch sensor is operating in the character mode. As illustrated, the third touch comprises a downward swipe 133a and an upward arc 133b that form an approximate outline of the English letter ‘D.’ With reference to FIG. 1A, the third touch may be interpreted as the English letter D and, in response, presentation of the list may be changed to a portion including items beginning with that letter.

In some cases, if a second letter is detected within a period of time (such as three seconds) after detection of the D, the list may be further navigated to items that begin with the letter D followed by the second character.

In various cases, the list, a user interface, and/or the second electronic device 102 may be configured to utilize a particular language (such as Spanish) and the character input may be one or more characters of a language other than the configured particular language (such as Japanese). In this way, character entry mode may be used to enable entry of characters of a language for which the list, user interface, and/or the second electronic device is not currently configured to utilize.

Although the present example is described as navigating to items of a list that begin with a character upon detection of that character, it is understood that this is an example. Various kinds of character input may be utilized to navigate various kinds of lists in various ways, such as navigating to list items that have a status associated with the detected character, navigating to items that a user has marked with the detected character, performing one or more actions associated with the character on one or more of the items, and/or any other such character interaction scheme.

Further, although the present example is described as an alphabetized list of television programs available for selection, it is understood that this is an example. In various cases, the list may be any kind of list which may be ordered (or not ordered, i.e. un-ordered) according to any kind of ordering scheme. Such lists may include a list of files stored on one or more storage media, a list of available programs or apps, a list of contacts, a list of settings and/or preferences, and/or any other such list.

Additionally, although the present example discusses a first electronic device 101 and a second electronic device 102, it is understood that this is an example. In some implementations, the functions of the first electronic device and the second electronic device may be performed by the same device.

Further, in examples including the first electronic device 101 and the second electronic device 102, various functions described as performed by one of the devices may be performed by the other without departing from the scope of the present disclosure. For example, in various examples, switching the mode of the touch sensor 104, interpreting touches detected by the touch sensor, and/or other such functions may be performed by the touch sensor, the processing unit 121, the processing unit 124, and/or other components.

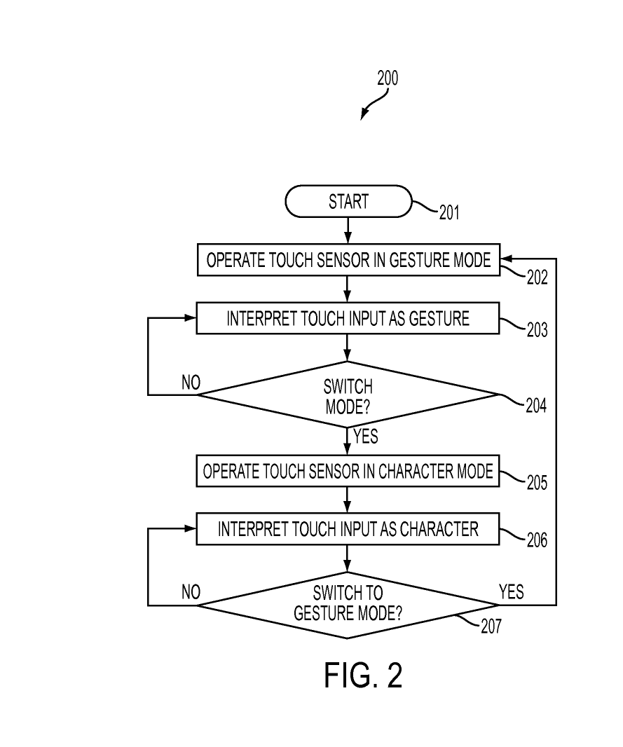

FIG. 2 is a flow chart illustrating a method 200 for input entry. This method may be performed by the system 100 of FIG. 1A.

The flow begins at block 201 and proceeds to block 202 where a touch sensor is operated in a gesture mode. The flow then proceeds to block 203 where touch input is interpreted as a gesture.

Next, the flow proceeds to block 204 where it is determined whether or not to switch mode to character mode. If so, the flow proceeds to block 205. Otherwise, the flow returns to block 203 where touch input is interpreted as a gesture.

At block 205, after the determination has been made to switch modes to character mode, the touch sensor is operated in the character mode. The flow then proceeds to block 206 where touch input is interpreted as a character.

Next, the flow proceeds to block 207 where it is determined whether or not to switch mode to gesture mode. If so, the flow proceeds to block 202 where the touch sensor is operated in gesture mode. Otherwise, the flow returns to block 206 where touch input is interpreted as a character.

Although the method 200 is illustrated and described above as including particular operations performed in a specific order, it is understood that this is an example. In various implementations, different arrangements of the same, similar, and/or different operations may be performed in varying order without departing from the scope of the present disclosure.

For example, the method 200 is described as starting in gesture mode and only switching to character mode if a determination is made to switch modes. However, in various implementations, the method may begin in character mode without departing from the scope of the present disclosure. In various other implementations, the method may include making a determination of which mode to operate in before operating in any mode and then operating in the determined mode.

By way of another example, the method 200 is illustrated and described as operating in either gesture mode and/or character mode. However, in other implementations, the method may operate in other modes and/or may operate in character mode and gesture mode simultaneously.

Although the present disclosure is illustrated and described as utilizing the gesture mode and/or the character mode to navigate one or more lists, it is understood that this is an example. In various cases, one or more of these modes may be utilized for various other purposes.

For example, character entry mode may be utilized when a user enters a password on a remote control device that includes a touch sensor. In this way, the user may be able to actually enter the characters of the password instead of selecting characters from a virtual keyboard or other user interface displayed on a screen and the user may be able to keep their password secret from people able to see the screen.

By way of another example, character entry mode may be utilized when a user needs to enter characters in a language not supported by a keyboard, virtual keyboard, and/or other user interface component. In this way, a user may occasionally be able to enter characters for a language which may not be supported by existing configured user interfaces.

In a third, example, the ability to switch between a character entry mode and a gesture mode may be utilized to enable support for both character input and gesture input utilizing a single touch sensor when another character input component is unavailable. In this way, fewer interface components may be necessary for a particular electronic device, reducing device complexity and/or cost.

In a fourth example, the ability to utilize a character mode may enable users to define functions to be performed when one or more user defined characters are detected. In this way, users may be able to associate functions with user defined characters to facilitate quicker and/or easier execution of the functions as opposed to utilizing gestures to navigate traditional user interfaces.

As described above and illustrated in the accompanying figures, the present disclosure discloses systems and methods for input entry. One or more touch sensors of an electronic device that may be used to navigate one or more presented lists may be operable in at least a gesture mode and a character mode. In the gesture mode, one or more touches detected by the touch sensor may be interpreted as gesture input for navigating the list. In the character mode, the touches may be interpreted as character input for navigating the list. The touch sensor may switch between the gesture mode, the character mode, and/or one or more various other modes.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A system for input entry, comprising:
at least one processing unit; and
at least one touch sensor;
wherein the at least one touch sensor is operable in at least a gesture mode where at least one touch detected by the at least one touch sensor is interpreted as at least one gesture input for navigating at least one list and a character mode where the at least one touch detected by the at least one touch sensor is interpreted as at least one character input for navigating the at least one list.

2. The system of claim 1, wherein the at least one touch sensor is incorporated into at least one remote control device that is operable to control at least one electronic device.

3. The system of claim 2, wherein the at least one processing unit is incorporated into the at least one remote control device.

4. The system of claim 2, wherein the at least one processing unit is incorporated into the at least one remote control device or the at least one electronic device.

5. The system of claim 1, wherein the at least one gesture input comprises at least one tap, touch, slide, swipe, or pinch.

6. The system of claim 1, wherein the at least one character input comprises at least one of at least one letter or at least one number.

7. The system of claim 1, wherein the at least one character input comprises at least one character of a first language and the at least one processing unit is configured to utilize a second language.

8. The system of claim 1, wherein the at least one character input comprises at least one user defined character.

9. The system of claim 1, wherein the at least one touch sensor switches from gesture mode to character mode in response to detecting a particular gesture associated with switching to character mode.

10. The system of claim 9, wherein the particular gesture is user defined.

11. The system of claim 1, wherein navigating the at least one list utilizing the at least one character input comprises navigating to a portion of the at least one list associated with the at least one character input.

12. The system of claim 11, wherein the portion of the at least one list is associated with the at least one character input because at least one item of the portion of the at least one list begins with the at least one character input.

13. The system of claim 11, wherein the at least one touch sensor detects at least one additional touch within a time period after detecting the at least one touch when operating in the character mode.

14. The system of claim 13, wherein the at least one processing unit further navigates the at least one list by navigating to part of the portion of the at least one list that is associated with at least one additional character input corresponding to the at least one additional touch.

15. The system of claim 14, wherein the part of the portion of the at least one list is associated with the at least one additional character input because at least one item of the part of the portion of the at least one list includes the at least one additional character input.

16. The system of claim 15, wherein the at least one item begins with the at least one character input followed by the least one additional character input.

17. The system of claim 1, wherein the at least one touch sensor switches from gesture mode to character mode when a user interface provided by the at least one processing unit is configured for character input.

18. The system of claim 1, wherein the at least one touch sensor switches from character mode to gesture mode when a user interface provided by the at least one processing unit is configured for gesture input.

19. The system of claim 1, wherein the at least one touch sensor switches from gesture mode to character mode in response to receiving at least one input from at least one hardware input selection element.

20. The system of claim 1, wherein the list comprises at least one of an ordered list or an un-ordered list.

21. A method for input entry, comprising:
interpreting at least one first touch input detected by at least one touch sensor as at least one gesture for navigating at least one list when operating the at least one touch sensor in a gesture mode;
determining to switch the at least one touch sensor to a character mode; and
interpreting at least one second touch input detected by the at least one touch sensor as at least one character for navigating the at least one list when operating the at least one touch sensor in a character mode.

22. An electronic device, comprising:
at least one processing unit; and
at least one touch sensor coupled to the at least one processing unit;
wherein the at least one touch sensor is operable in at least a gesture mode where at least one touch detected by the at least one touch sensor is interpreted as at least one gesture input for navigating at least one list and a character mode where the at least one touch detected by the at least one touch sensor is interpreted as at least one character for navigating the at least one list.
